(19) United States
(12) Patent Application Publication
(10) Pub. No.: US 2011/0067050 A1
(43) Pub. Date: Mar. 17, 2011

(54) System and Method for Enhancing Video Data

(75) Inventor: Jacob Samboursky, Hertzelia (IL)

(73) Assignee: AD-FUSE TECHNOLOGIES LTD., Sde Boker (IL)

(21) Appl. No.: 12/561,414

(22) Filed: Sep. 17, 2009

(51) Int. Cl. H04N 7/16; H04N 7/173; H04N 7/025

(52) U.S. Cl. 725/30; 725/116; 725/34

(57) ABSTRACT

A method and a system for enhancing video data that enable: receiving an original video data file comprising video data; enhancing the received original video data file by integrating a controller program into the received original video data file, where the receiving and enhancing is carried out by at least one remote server, and where the controller program enables executing operations according to predefined rules; playing the enhanced video file; and operating the controller program, wherein the controller program is operated upon and during playing of the video content, wherein the operating of the controller program includes executing the operations included therein according to the predefined rules, and wherein the operations enable adding information related to the video data.

### BACKGROUND

1. Technical Field

The present invention relates to the field of enhancing video content, and more particularly, to enhancing of video content.

2. Discussion of Related Art

Viewing video data distributed over different communication networks such as the internet, is an ever growing phenomena. Video data sources such as designated websites (such as Youtube and others) often allow real time streaming of video data as well as downloading of video content for later viewing. Those data sources usually distribute the same data to all users of all channel types and do not allow enhancement of the video data according to the user or channel, the data is viewed or downloaded from.

There is a need to customize the video data for each user and provide each user with means to interact while viewing.

### BRIEF SUMMARY

According to one aspect of the invention, there is provided a computer-implemented method of enhancing video data that enables: receiving an original video data file comprising video data; enhancing the received original video data file by integrating a controller program into the received original video data file, where the receiving and enhancing is carried out by at least one remote server, and where the controller program enables executing operations according to predefined rules; downloading the enhanced video file, where a user downloads the enhanced video file; playing the downloaded enhanced video file; and operating the controller program, wherein the controller program is operated upon and during playing of the video content, wherein the operating of the controller program includes executing the operations included therein according to the predefined rules, and wherein the operations enable adding information related to the video data.

The adding of information may include adding information to the viewed and played video file and/or transmitting information to the remote server.

According to another aspect of the invention, there is provided a data processing system for enhancing video data. The system may comprise a remote server arranged to receive video data files from a content source, enhance the received video data files by integrating a controller program to the received video data files and transmit data over at least one communication link. The system may further enable a user to download and play the enhanced video data file, wherein the controller program of the downloaded enhanced video data file is operated upon and during playing of the video content of the enhanced video data file, where the operating of the controller program includes executing the operations included therein according to predefined rules included in the controller program, and wherein the operations enable adding information related to the video data.

According to yet another aspect of the invention, there is provided a computer-implemented method of enhancing video data, comprising: providing an enhanced video file including video data and a controller program integrated to the video data, wherein the controller program enables executing at least one predefined operation, according to predefined rules; downloading the enhanced video file, wherein a user downloads the enhanced video file; playing the downloaded enhanced video file; and operating the controller program, wherein the controller program is operated upon and during playing of the video content, wherein the operating of the controller program includes executing the operations included therein according to the predefined rules, and wherein the operations enable adding information related to the video data.

### BRIEF DESCRIPTION OF THE DRAWINGS

The present invention will be more readily understood from the detailed description of embodiments thereof made in conjunction with the accompanying drawings of which:

FIG. 1 is a high level flowchart illustrating a computer-implemented method of enhancing original video data files, according to some embodiments of the invention;

FIG. 2 is a high level flowchart illustrating a computer-implemented method of operating an enhanced video data file, according to some embodiments of the invention;

FIG. 3 is a high level schematic block diagram of a data processing system for enhancing video data files, according to some embodiments of the invention; and

FIG. 4 is a high level schematic block diagram of a managing tool for enhancing original video data files, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Prior to setting forth the detailed description of some embodiments of the invention, it may be helpful to set forth definitions of certain terms that will be used hereinafter.

The term “user” may refer to any computerized and communication system or terminal known in the art such as, for example, a PC, a laptop, a mobile phone, a PAD, etc.

The term “content source” may refer to any content provider known in the art using any content providing and distributing technology.

The term “communication link” may refer to any data communication network known in the art such as, for example, the internet, an intranet, a wireless communication network and the like.

The term “video data file” may refer to any file including media data such as video data and/or audio data.

The term “video data” may refer to any media content and operation code known in the art enabling users to play and view video and/or audio and/or any other type of media files.

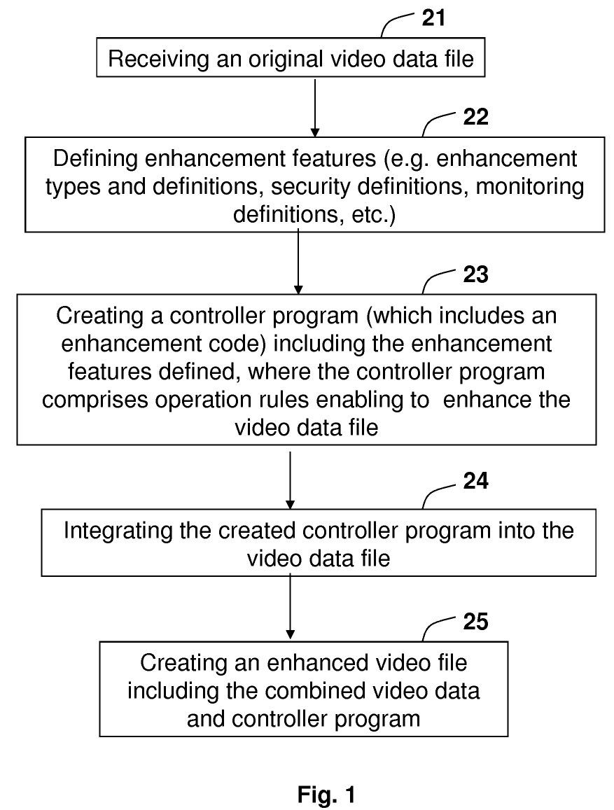

FIG. 1 is a high level flowchart illustrating a computer-implemented method of enhancing original video data files, according to some embodiments of the invention.

The computer-implemented method may comprise the following stages:

Receiving an original data file 21 (e.g., where a remote server receives the original video data file from a content source);
defining enhancement features 22 such as the type of enhancement and the enhancement parameters and definitions;
Creating a controller program 23, which may be a program code, enabling to execute operations according to the enhancement definitions, which include rules according to which the operations are to be executed;
Integrating the created controller program to the original video data file 24 (e/g/, by integrating the content of the original video data file with the code of the controller program); and
Creating an enhanced video data file including both the video data of the original data file and the controller program 25.

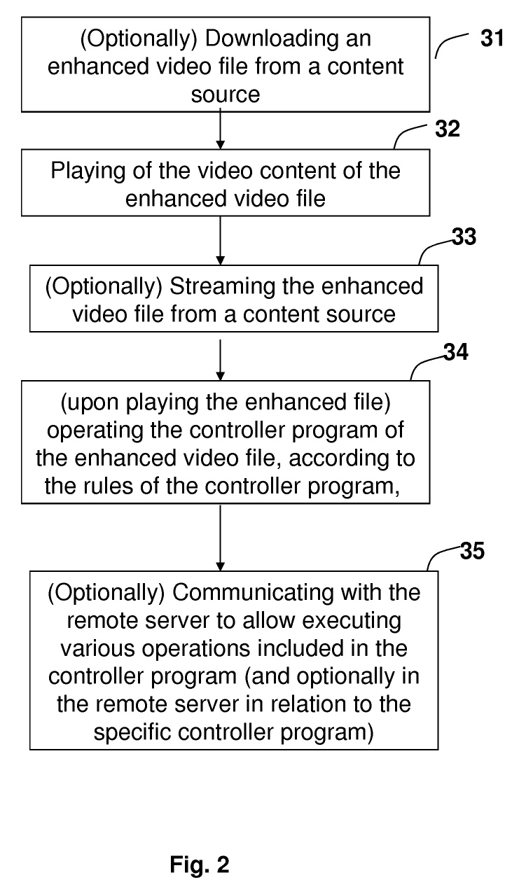

FIG. 2 is a high level flowchart illustrating a computer-implemented method of operating an enhanced video data file, according to some embodiments of the invention. This method may comprise the steps of:

(Optionally) Downloading an enhanced video data file (e.g. from any content source or from the remote server) 31;
Playing the enhanced video data file to view the content data thereof 32;
(Optionally—in case the file was not downloaded) Streaming the data of the enhanced video file 32;
(upon playing of the file) Operating the controller program of the enhanced video data file according to the rules of the controller program 34 (e.g., from the user terminal); and
(Optionally) Communicating with the remote server for executing the operations according to the rules 35.

According to some embodiments, the operations carried out by the controller program may include an operation code for enabling to operate other predefined operations by the remote server according to other rules and according to the specific controller program associated therewith (e.g., where the controller program is a loader code).

Alternatively, most or all the operations may be carried out by the controller program using the user as a client to execute these operations.

According to some embodiments, the operations may include at least one of: (1) sending user viewing data to the remote server (e.g. for allowing monitoring of the user's viewing behavior and characteristics); (2) receiving data from the remote server by the controller program (e.g. receiving information relating to the video that is played, receiving advertising messages); (3) placing advertising content in the video content; and (4) enabling the user to interact with other users (e.g. users that are currently watching the same video data) by, for example, identifying at least one other user viewing the same video content, suggesting the user to communicate with the at least one other user substantially immediately while viewing the video content and supporting the communication between those users.

According to some embodiments the placing of advertising content in the video content (option (3) in the previous paragraph) may include integration of an image into the original video content in such a way that the image will seem like it was a part of the original scene in the video content.

According to embodiments, execution of the operations of the controller program may be carried out substantially immediately during viewing and playing of the video content by the user.

According to some embodiments, the enhanced video file may be streamed through a communication network from a website enabling users to view media files by streaming the data from a designated server to the user. In these embodiments the file may not be downloaded to the user. The operations may be executed by the controller program and/or by the remote server once the enhanced video file is played and while its content is streamed to the user.

According to some embodiments of the invention, communicating with the remote server, receiving data there-from and enhancing the video content are carried out automatically without any user action relating thereto. These stages may further be carried out without disturbing the viewing of the video content of the enhanced video data file.

According to some embodiments of the invention, the controller program may comprise a loader code arranged to initiate downloading a main program from the remote server, and/or receiving data from the remote server by the controller program may comprise downloading the main program from the remote server. Receiving data from the remote server by the controller program may also comprise receiving updates from the controller program relating to communicated data of user actions and updating the controller program therewith.

According to some embodiments of the invention, the received data may comprise personalized content related to the user or advertising content that may be selected according to characteristics of the user and of the viewed video content.

According to some embodiments of the invention, the video content of the video data of the original and therefore the enhanced video data file may comprise a FLASH file, where the integrating of the controller program may comprise integrating the controller program into the FLASH file.

According to some embodiments of the invention, integrating controller program may be carried out such that it arrives the user with the video content irrespective of the path of the video content from its source.

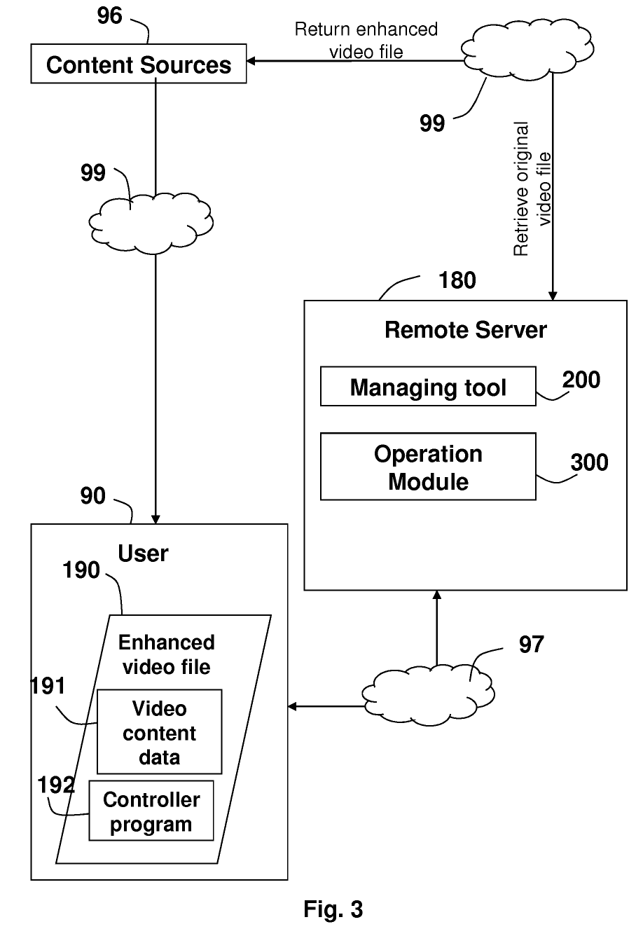

FIG. 3 is a high level schematic block diagram of a data processing system for enhancing original video data files comprising video data, according to some embodiments of the invention.

According to these embodiments, the system may comprise a remote server 180 arranged to receive video data files from one or more content sources 96, enhance the received video data files by integrating a specific controller program 192 to the received video data files according to predefined requirements and transmit data over at least one communication link 99 and/or 97. The resulting enhanced video file 190 may comprise video content data 191 of the original video data file and the controller program 192.

The system may further enable one or more users 90 to play the enhanced video data file 190 (either by downloading the enhanced video file 190 and then playing it or by streaming the data of the enhanced video file 190 once the user 90 plays the file from a designated website such as source 96), and wherein controller program 192 of the downloaded enhanced video data file 190 is operated upon and during playing of the video content of enhanced video data file 190.

Operation of controller program 192 may include communicating with remote server 180 and executing the operations included in controller program 192, according to predefined rules included in controller program 192, where the operations enable adding information related to the video data. The adding of information may include adding information to the viewed and played video file (e.g., by allowing users to communicate with one another, to view additional content and/or to view placed ads in the content of the video data file) and/or transmitting information to remote server 180 (e.g., by transmitting monitored viewing related data of the user).

Remote server 180 is further arranged to receive data from, and send data to controller program 190 (e.g., via a communication link 97) such as to enhance video content with the sent data substantially during viewing of the video content of the enhanced video data file 190 by user 90.

According to some embodiments of the invention, controller program 190 may be integrated into video content at various stages, ranging from initial production to an actual streaming transmission. Controller program 190 is integrated in video content before it reaches user 90, and upon its receipt, operates automatically without disturbing the viewing of video content by user 90. For example, controller program 190 may be integrated in a FLASH file. Integrating controller program 190 may be carried out such that it arrives user 90 with video content irrespective of the path of video content via communication link 99.

According to some embodiments of the invention, controller program 190 may send data to remote server 180 that comprises user characteristics and viewing characteristics such as content, references and other parameters. According to some embodiments of the invention, remote server 180 may be further arranged to send data to user 90 in relation to user's 90 characteristics and parameters (e.g. profile) of viewing parameters of user 90.

According to some embodiments of the invention, controller program 190 may be a loader code arranged to download a main application from remote server 180 upon viewing video content. Upon receipt of the data, remote server 180 may identify user 90 and derive content to be sent to user 90 while viewing the video content, such as personalized advertisements and suggestions or processed content relating to the viewed video content in relation to the timing of viewing. During viewing, controller program 190 may continue to collect data relating to user 90 and the viewing, send the data to remote server 180 and receive further enhancements to video content. User 90 may also select enhancements or define preferences relating to the supplied enhancements. For that purpose controller program 190 may present an interface to the user allowing him to select the preferred enhancements and/or enhancement's features and execute operations according to the selected enhancements and features and the predefined enhancements and features.

According to some embodiments of the invention, controller program 190 may send data to remote server 180 that comprises user characteristics and viewing characteristics such as content, references and other parameters.

According to some embodiments of the invention, remote server 180 may be further arranged to update controller program 190 in relation to the data received therefrom.

According to some embodiments of the invention, controller program 190 may be removed from user 90 upon the termination of playing of enhanced video data file 190.

According to some embodiments of the invention, remote server 180 may be further arranged to detect and connect users 90 viewing the same video content (e.g., over communication link 99). Users 90 may then be allowed to share and exchange comments and content relating to video content. Users 90 may be further connected via other websites, such as social networks, forums etc.

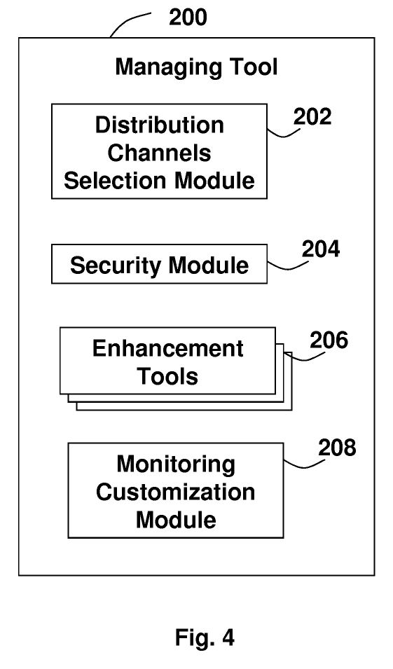

According to some embodiments of the invention, as illustrated in FIG. 4, remote server 180 may comprise: a managing tool 200 comprising a distribution channels selection module 202 arranged to allow an authorized user to select distribution channels and content sources 96;

a security module 204 arranged to allow inputting security codes used to identify specific users 90, specific controller programs 190 and enhanced video data;
enhancement tools 206 arranged to allow the authorized user to define and construct controller programs 190 according to various requirements and characteristics; and
a monitoring customization module 208 allow the authorized user to define monitoring features for monitoring users viewing behavior when playing enhanced video data file 190.

According to some embodiments of the invention, controller program 190 may comprise a controller computer usable program code tangibly embodied on a computer usable medium. The controller computer usable program code may comprise: (optionally) a computer usable program code for integrating the controller computer usable program code into video content; a computer usable program code for initiating communication with remote server 180 upon viewing video content with the integrated controller computer usable program code by user 90; a computer usable program code for communicating with remote server 180 and receiving data therefrom; and a computer usable program code for enhancing video content with the received data substantially immediate during viewing of video content by user 90.

According to some embodiments of the invention, the controller computer usable program code further comprises a computer usable program code for connecting different users 90 viewing the same video content.

According to some embodiments of the invention, the controller computer usable program code further comprises a computer usable program code for updating the controller computer usable program code.

According to some embodiments of the invention, the data processing system may comprise tools for generating and integrating controller program 190 to video content, including indications of content sources 96 and communication links 97, 99 and parameters thereof. Controller program 190 may be coded in various ways adapted to these parameters.

Data relating to users 90 and viewing may comprise personal details, timing data, interactively inputted data, and results of transactions, advertisements included in video content or data relating to objects presented or included in video content. The data may further comprise events happening during the viewing such as interruptions, pauses, preferred parts as well as visual characters such as audio intensity, monitor parameters etc.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A computer-implemented method of enhancing video data, comprising:
receiving an original video data file comprising video data;
enhancing said received original video data file by integrating a controller program into the received original video data file, wherein said receiving and enhancing is carried out using at least one remote server, and wherein said controller program enables executing operations according to predefined rules;
playing the enhanced video file, wherein a user plays said enhanced video file; and
operating said controller program, wherein said controller program is operated upon and during playing of the enhanced video file, wherein said operating of said controller program includes executing the operations included therein according to the predefined rules, and wherein said operations enable adding information related to the video data.

2. The computer-implemented method of claim 1, further comprising downloading said enhanced video file, wherein a user downloads said enhanced video file and then plays said downloaded file.

3. The computer-implemented method of claim 1, further comprising streaming the data of said enhanced video file, wherein said streaming is carried out once the user plays said enhance video file.

4. The computer-implemented method of claim 1, further comprising communicating with a remote server, wherein upon playing of the enhanced video file, said controller program enables communicating with at least one remote server for executing at least some of the operations of the controller program, according to the predefined rules.

5. The computer-implemented method of claim 4, wherein the communicating with a remote server by the controller program comprises sending user viewing data to the remote server for monitoring viewing behavior of said user.

6. The computer-implemented method of claim 4, wherein the controller program comprises a loader code arranged to download a main program from the remote server, and wherein said downloaded main program enables executing the predefined operations according to predefined rules associated with the specific controller program.

7. The computer-implemented method of claim 4, wherein said communicating with a remote server further includes updating the controller program.

8. The computer-implemented method of claim 4, wherein said communicating with the remote server further includes receiving data from said at least one remote server, which includes personalized content related to the user.

9. The computer-implemented method of claim 8, wherein the received data comprises advertising content.

10. The computer-implemented method of claim 1 further comprising allowing the integration of images into the video frames in such a way that the images will seem like they were a part of the original scene.

11. The computer-implemented method of claim 1, further comprising allowing the user to communicate with other users via the controller program and over the remote server.

12. The computer-implemented method of claim 11, further comprising identifying at least one other user viewing the same video content, suggesting the user to communicate with the at least one other user substantially immediately while viewing the video content and supporting said communication between the users.

13. The computer-implemented method of claim 1, wherein the video data content comprises a FLASH file, and wherein the integrating the controller program comprises integrating the controller program into the FLASH file.

14. A data processing system for enhancing video data comprising
a remote server arranged to
receive video data files from a content source, and
enhance the received video data files by integrating a controller program to the received video data files and transmit data over at least one communication link,
wherein said system further enables a user to play said enhanced video data file, wherein the controller program of the played enhanced video data file is operated upon and during playing of the video content of the enhanced video data file,
wherein said operating of said controller program includes executing the operations included therein according to predefined rules included in said controller program, and
wherein said operations enable adding information related to the video data.

15. The data processing system of claim 14, wherein said controller program further enables communicating with a remote server once the enhanced video file is played.

16. The data processing system of claim 15, wherein the remote server is further arranged to detect and connect users viewing the same video content substantially at the same time.

17. The data processing system of claim 15, wherein the remote server is further arranged to send data to the user in relation to user characteristics and parameters of the viewed video content.

18. The data processing system of claim 15, wherein the remote server is further arranged to update the controller program in relation to the data received therefrom.

19. The data processing system of claim 15, wherein the remote server further comprises:
a managing tool for enabling an authorized user to enhance an original video data file by defining enhancement features and types using said tool; and
an operation module for enabling to transmit and receive data to and from said controller program executed by the user and to execute operations according to predefined rules.

20. The data processing system of claim 13, wherein said enhanced video data file includes integration of images into the original video content in such a way that the images will seem like it was a part of the original scene.

21. The data processing system of claim 20, wherein said managing tool comprises:
a distribution channels selection module arranged to allow selection of distribution channels for distributing the enhanced video data files and the content sources for receiving the original video data file for enhancement;
a security module arranged to allow inputting security codes used to identify specific users and specific controller programs and enhanced video data;
enhancement tools arranged to define and construct the controller programs according to user requirements and characteristics; and
a monitoring customization module arranged to allow the authorized user to define monitoring features for monitoring users viewing behavior when playing the enhanced video data file,
wherein the managing tool may be used by at least one authorized user to distribute content to the users.

22. A computer-implemented method of enhancing video data, comprising:
providing an enhanced video file including video data and a controller program integrated to said video data, wherein said controller program enables executing at least one predefined operation, according to predefined rules;
playing the enhanced video file, wherein a user plays said enhanced video file; and
operating said controller program, wherein said controller program is operated upon and during playing of the enhanced video file, wherein said operating of said controller program includes executing the operations included therein according to the predefined rules, and wherein said operations enable adding information related to the video data.

23. The computer-implemented method of claim 22, further comprising integrating the controller program for enhancing said original video file, wherein an authorized user integrates said controller program.

24. The computer-implemented method of claim 22, further comprising downloading said enhanced video file, wherein a user downloads said enhanced video file and then plays said downloaded file.

25. The computer-implemented method of claim 22, further comprising streaming the data of said enhanced video file, wherein said streaming is carried out once the user plays said enhance video file.

26. The computer-implemented method of claim 22, further comprising communicating with a remote server, wherein upon playing of the enhanced video file, said controller programs enables communicating with a remote server for executing at least some of the operations of the controller program, according to the predefined rules.
